(19) United States
(12) Patent Application Publication
(10) Pub. No.: US 2009/0009526 A1
(43) Pub. Date: Jan. 8, 2009

(54) METHOD AND SYSTEM FOR RENDERING A SHAPE

(75) Inventors: Daniel Stuart Rice, San Francisco, CA (US); Vincent Julien Hardy, Palo Alto, CA (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 11/833,334

(22) Filed: Aug. 3, 2007

(30) Foreign Application Priority Data
Jul. 3, 2007 (EP) 07301202.3

(51) Int. Cl. G09G 5/02

(52) U.S. Cl. 345/589; 345/581

(57) ABSTRACT

A method for rendering an image that includes obtaining pixel coverage data for a first shape from a graphics cache, determining a first portion of the image covered by the first shape using the pixel coverage data for the first shape, and displaying the image with the first portion of the image covered by the first shape.

### CROSS-REFERENCE TO RELATED APPLICATIONS

This application claims benefit of European Patent Application No. 07301202.3 entitled “Method and System for Rendering a Shape,” filed on Jul. 3, 2007 in the names of Daniel Stuart Rice and Vincent Julien Hardy and is hereby incorporated by reference.

### BACKGROUND

One of the tasks that a computer performs is the rendering of an image on the screen. An image is a computer generated pictorial representation which is composed of pixels, each having specific color values. In general, a computer creates an image from a set of instructions in a graphics application. When the graphics application uses vector graphics, the pixel values in a destination image are computed from a set of shapes and associated rendering properties, such as fill colors or stroking properties. The shape, either basic (e.g., circles, rectangles, etc.) or complex (e.g., Bezier curves), is converted into pixel values using a process called rasterization. The graphics application may define the set of shapes to be rendered in a vector graphics image format, such as scalable vector graphics (SVG), or as a set of application programming interface (API) calls, such as calls to JAVA 2D™ API methods. JAVA 2D™ is a trademark of Sun Microsystems Inc. located in Santa Clara, Calif.

In order to display an image, a graphics application typically computes rendering attributes (e.g., fill color, coverage data, composition rules) of each shape in the image and then renders each shape into the destination surface. In order to render a shape, the graphics application executes the collection of equations for the shape to determine which pixels are a part of the shape (i.e., to calculate pixel coverage data. For example, the graphics application may calculate the cubic and quadratic Bezier curves to define the boundaries of the shape. The graphics application also determines the fill characteristics (e.g., how the shape is filled). After or while determining the filled areas of a shape, the graphics application may determine the color of each pixel in a filled area. The color is typically defined in the graphics application as a property of the shape Further, the graphics application may render the shape on a destination surface by combining information about the boundary of the shape, the fill characteristics, the color, and the background in a compositing step. This composition may then be displayed.

Typically, before the image is displayed, the composition may be stored in an image buffer. In general, the image buffer only includes information which specifies a color for each pixel in the image rather than information that identifies each distinct shape in the image.

If the image is changed after the image is displayed (e.g., a shape in the image is moved or resized), the graphics application typically repeats the rendering and display process for the image. In particular, the pixel coverage data for each shape is recalculated.

### SUMMARY

In general, in one aspect, the invention relates to a method for rendering an image that includes obtaining pixel coverage data for a first shape from a graphics cache, determining a first portion of the image covered by the first shape using the pixel coverage data for the first shape, and displaying the image with the first portion of the image covered by the first shape.

In general, in one aspect, the invention relates to a system for rendering an image that includes a graphics cache and a graphics application. The graphics cache is configured to store pixel coverage data for a plurality of shapes. The graphics applications is configured to obtain pixel coverage data for a first shape of the plurality of shapes from the graphics cache, to determine a first portion of the image covered by the first shape using the pixel coverage data for the first shape, and to display the image with the first portion of the image covered by the first shape.

In general, in one aspect, the invention relates to a computer readable medium including computer readable program code embodied therein for causing a computer system to obtain pixel coverage data for a first shape from a graphics cache, to determine a first portion of the image covered by the first shape using the pixel coverage data for the first shape, and to display the image with the first portion of the image covered by the first shape.

Other aspects of the invention will be apparent from the following description and the appended claims.

### BRIEF DESCRIPTION OF DRAWINGS

FIG. 1A shows a schematic diagram of a system in accordance with one or more embodiments of the invention.

FIGS. 1B-D show example images with example shapes in accordance with one or more embodiments of the invention.

FIG. 2 shows a flowchart of a method in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for rendering a shape in an image. Specifically, embodiments of the invention store pixel coverage data in a graphics cache. The pixel coverage data specifies which pixels of an image are covered by a shape. Moreover, the pixel coverage data does not include the color of the pixels. In some embodiments of the invention, the pixel coverage data for a shape is added to the graphics cache the first time a shape is rendered. When the shape in the image changes (e.g., the position of the shape changes or the color of the shape changes), the pixel coverage data from the graphics cache may be used to render the changed shape instead of recalculating the pixel coverage data.

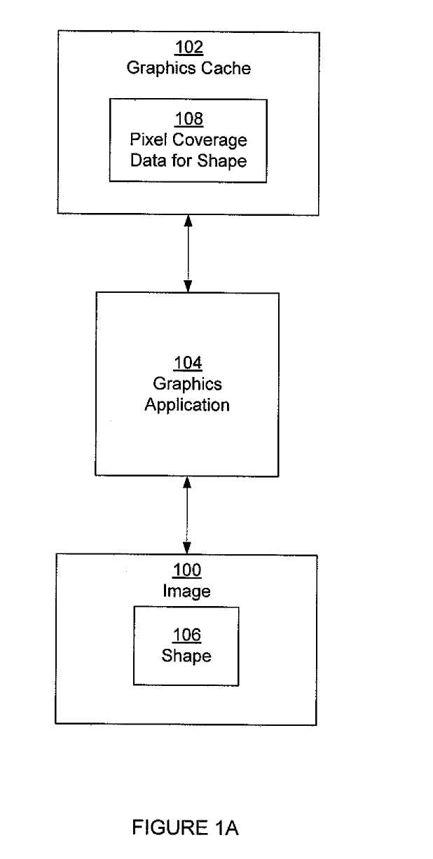

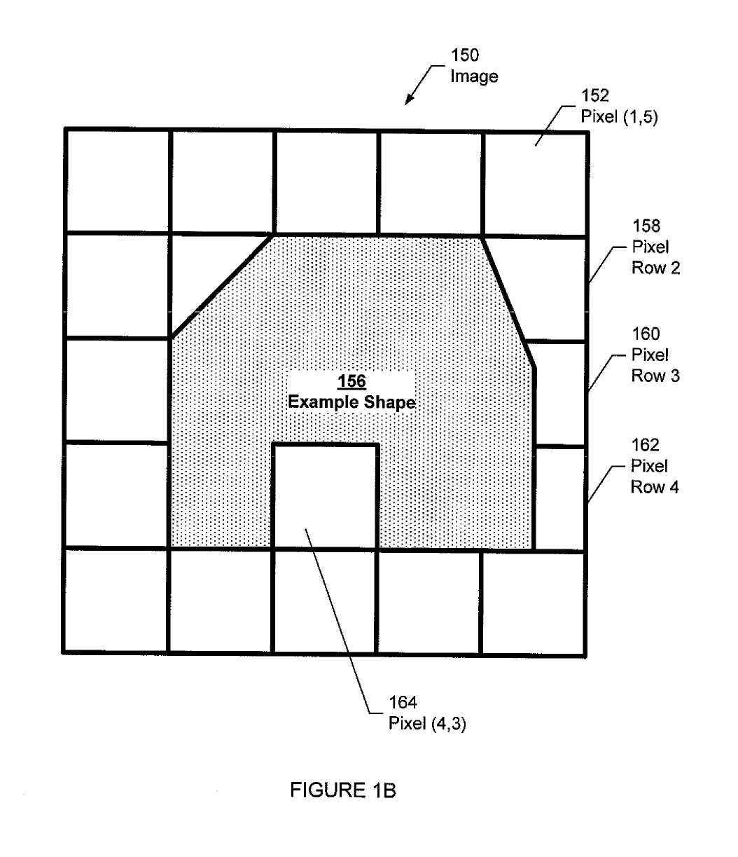

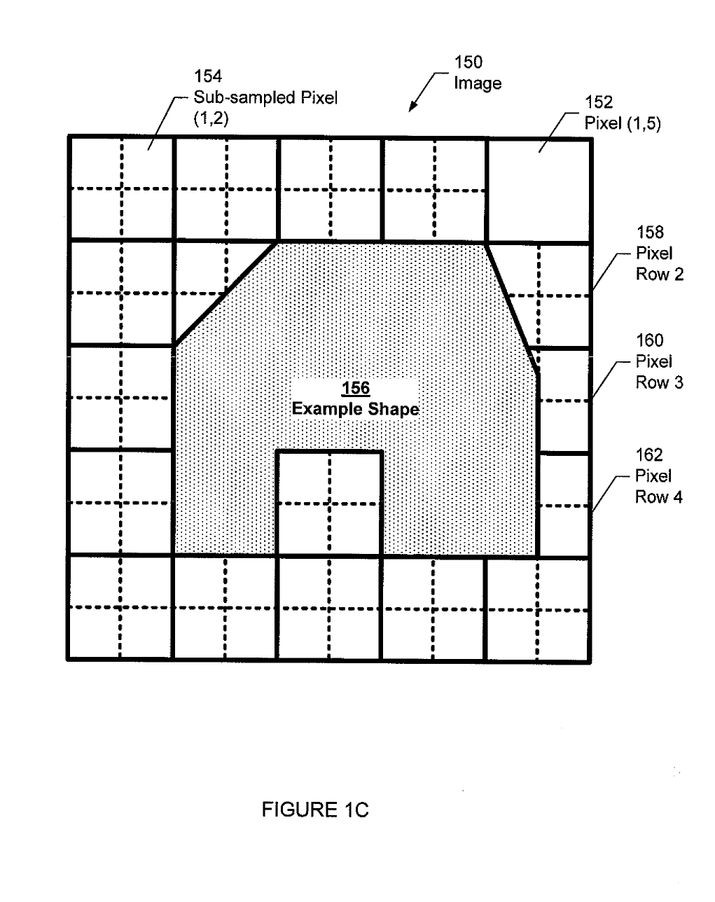

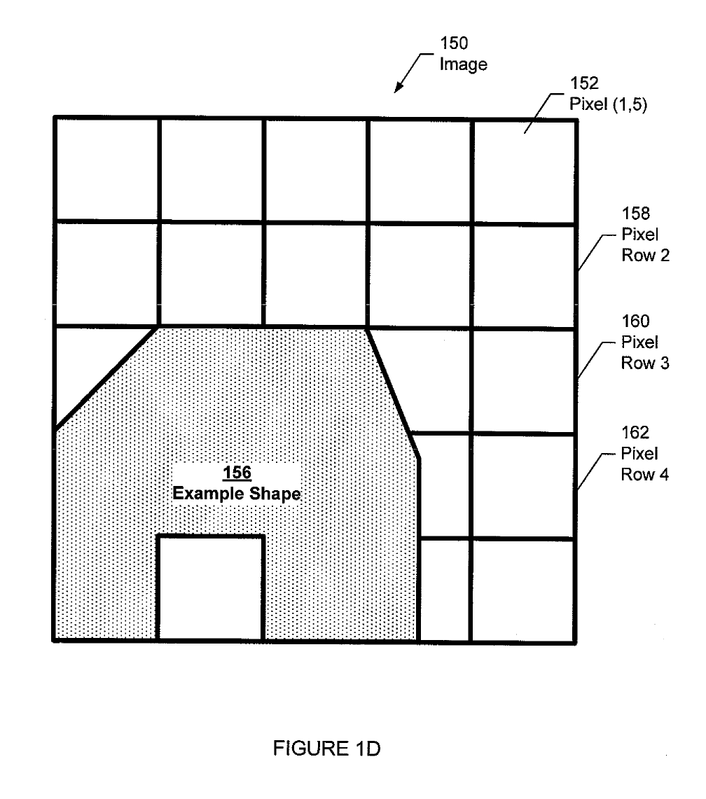

FIG. 1A shows a schematic diagram of a system in accordance with one or more embodiments of the invention. As shown in FIG. 1, the system includes an image (100), a graphics cache (102), and a graphics application (104). Each of these components is described below.

An image (100) is any type of computer generated pictorial representation. An image as discussed below is the output raster image which includes color values for the pixels on the target rendering surface or destination. The shapes (e.g., shape (106)) within the image (100) and subsequently the image (100) are created by executing a graphics application (104) (described below). Specifically, the graphics application (104) defines an input vector graphics image as a set of mathematically defined shapes with the rendering properties of the shapes (e.g., fill style, transformation, etc.).

FIG. 1B shows an example image (150). For the example image (150) of FIG. 1B, consider the scenario in which the example image has five rows of pixels and five columns of pixels as denoted by the solid dark lines forming a grid. A numbering system may be added to the rows and columns such that the first row, starting from the top, is row 1 and the first column, starting from the left, is column 1. One notation to define a pixel is as an ordered pair (row, column). Thus, as shown in FIG. 1B, pixel (1, 5) (152) is in the first row and the last column. Further, as shown in FIG. 1B, the example target image (150) includes the rendering of an example shape (156). Specifically, the example shape (156) covers a portion of pixel (2, 2), pixel (2, 5), pixel (3, 5), pixel (4, 5), as well as all of the following pixels: pixel (2, 3), pixel (2, 4), pixel (3, 2), pixel (3, 3), pixel (3, 4), pixel (4, 2), and pixel (4, 4).

Each pixel may be further partitioned into smaller sections. Each of the smaller sections is called a sub-sampled pixel. FIG. 1C shows the example image (150) with sub-sampled pixels. In FIG. 1C, the sub-sampled pixels are denoted by the dashed lines. For clarity, pixel (1, 5) (152) is shown without the sub-sampled pixels. In the example of FIG. 1C, each pixel is partitioned into sixteen sub-sampled pixels. In the example, sub-sampled pixel (1, 2) of pixel (1, 1) (154) is in the first row, second column of the pixel in the first row, first column of the grid.

While FIG. 1B shows five rows of pixels and five columns of pixels, in actuality more or fewer pixels may be used according to the configuration of the system. Further, in one or more embodiments of the invention, the number of sub-sampled pixels may also change according to the system. The example of FIG. 1B is intended for exemplary use only.

Returning to FIG. 1A, in order to render an image (100), a graphics cache (102) is used in one or more embodiments of the invention. A graphics cache (102) is a storage area for pixel coverage data (108) for shapes (106) in the image (100). In one or more embodiments of the invention, the graphics cache (102) is a data structure in memory that is reserved when the graphics application (104) is executed. In some embodiments of the invention, a graphics cache (102) may include a separate shape cache (not shown) for each shape (106) in the image (100). A shape cache includes the pixel coverage data (108) for the corresponding shape (106) in the image (100). Pixel coverage data (108) is data which defines which pixels and/or sub-sampled pixels in the image are covered by the rendered shape (106). Specifically, pixel coverage data (108) specifies the exact pixels which are touched by the shape. Using the pixel coverage data, the portion of the image that is covered by the shape may be identified.

The granularity of the pixel coverage data (108) in the graphics cache may be defined in terms of complete pixels or in terms of sub-sampled pixels. In the scenario in which the pixels coverage data is defined in terms of complete pixels, the sub-sampled pixels may be ignored in the pixel coverage data (108). Alternatively, if the pixel coverage data (108) is defined in terms of sub-sampled pixels, then the number of sub-sampled pixels for each pixel may be configured according to the memory and accuracy requirements of the graphics application in one or more embodiments of the invention.

When pixel coverage data (108) for the shape (106) is calculated, the shape (106) may be divided in to chunks (not shown). A chunk is a subset of the shape (106). For example, a chunk may be a subset of the contiguous pixels covered by the shape (106). A chunk may be one or more rows of pixels. In the alternative scenario in which the pixel coverage data is defined in terms of sub-sampled pixels, a chunk may be one or more rows or columns of sub-sampled pixels.

If the shape (106) is divided into chunks, the pixel coverage data describes each chunk. Specifically, the shape cache (described above) for a shape (106) may be divided into pixel coverage data (108) for each chunk. That is, each chunk in the pixel coverage data for the shape (106) is specified in terms of variables defining the position of the chunk, the width of the chunk, height of the chunk, an offset and length for each row of pixels or sub-sampled pixels in the chunk, and an alpha variable for each pixel or sub-sampled pixel in the chunk. If the shape (106) is not divided into chunks, the shape is treated a single chunk. That is, the pixel coverage data for the shape (106) as a whole is specified in terms of these variables. Each of the variables is described below.

In one or more embodiments of the invention, the position variable specifies the position of the chunk with respect to the image (100). When the shape (106) is initially rendered, the value of the position variable may be the first pixel or sub-sampled pixel in the chunk that is displayed when the image (100) is displayed. In one or more embodiments of the invention, the position variable is updated when the shape (106) is moved in the displayed image (100).

The height variable represents the number of rows of pixels or sub-sampled pixels that are affected by the chunk. A pixel/sub-sampled pixel is affected by the chunk when the chunk covers at least a portion of the pixel. Similar to the height variable, the width variable specifies the number of columns of pixels or sub-sampled pixels that are affected by the chunk in accordance with one or more embodiments of the invention.

In addition to the position variable, the width variable, and the height variable, the pixel coverage data for a chunk may also include an offset variable and a length variable for each row of pixels or sub-sampled pixels in the chunk. In one or more embodiments of the invention, the offset and length are maintained as an array of values in which each element in the array represents a row of pixels or sub-sampled pixels in the chunk. An offset specifies the first pixel or sub-sampled pixel in which the row starts. For example, if the first row covered by the chunk has three sub-sampled pixels and only the third sub-sampled pixel is covered by the chunk, then the offset may be two, since the first two sub-sampled pixels are not covered by the chunk. The length specifies the number of pixels or sub-sampled pixels in the row in the chunk.

As an alternative to an offset variable and length variable, the variables may include a minimum touched variable and a maximum touched variable for each row. The minimum touched variable may specify the first pixel or sub-sampled pixel covered by the shape in the row. The maximum touched variable may specify the last pixel or sub-sampled pixel covered by the shape in the row.

The pixel coverage data may also include an alpha variable for each pixel or sub-sampled pixel. Specifically, if the pixel coverage data is described in terms of complete pixels, an alpha variable exists for each pixel. Alternatively, when the pixel coverage data is described in terms of sub-sampled pixels, an alpha may exist for each sub-sampled pixel. The alpha variable defines the portion of the pixel or sub-sampled pixel covered by the shape.

The value of the alpha variable is between zero and one, inclusive. A value of zero specifies that none of the pixel/sub-sampled pixel is covered by the shape and a value of one specifies that the entire pixel/sub-sampled pixel is covered by the shape. Further, a value of one third is used to specify that only a third of the entire pixel/sub-sampled pixel is covered by the shape. In one or more embodiments of the invention, the value of the alpha variables is limited to zero or one when sub-pixels are used. One skilled in the art would appreciate that the alpha variable may define the portion of the pixel not covered by the shape.

Continuing with the alpha variables, one possible mechanism for storing the values of the alpha variables is to use an ordered list, such as an array. Using an ordered list, rows or columns in the chunks may be stored consecutively. Thus, the alpha values for the first row of the chunk may be followed by the alpha values for the second row, etc. Further, a list offset may be maintained for each row covered by the chunk. The list offset may specify the position of the first alpha value in the list for the row. Alternatively, other storage mechanisms may also be used, such as a two dimensional array.

As an example of the pixel coverage data in terms of complete pixels, consider example image (150) in FIG. 1B. Note that the example shape (156) in FIG. 1B covers three rows of pixels (i.e., pixel row 2 (158), pixel row 3 (160), and pixel row 4 (162)). Further, note that pixel (4, 3) (164) of pixel row 4 (162) is not covered by the shape.

The example shape (156) may be defined in the graphics cache with any number of chunks. For example, the example shape may be defined as a single chunk, two chunks, three chunks, etc. For the following example, consider the scenario in which the example shape (156) is defined in the graphics cache as having two chunks, chunk 1 and chunk 2. Chunk 1 describes the shape in pixel row 2 (158) and pixel row 3 (160) and chunk 2 describes the shape in pixel row 4 (162).

Chunk 1 has a position (2, 2) because the chunk starts on pixel (2, 2). Further, chunk 1 has a height of two and width of four because the chunk covers two rows of pixels and four columns of pixels. Within this chunk, an offset and length pair is described for each row of pixels. The offset and length are zero and four, respectively, for each row of pixels because all pixels in the chunk are fully or partially covered. The alpha variables are described for each pixel in the chunk as follows: pixel (2, 2) has a value of one half, pixel (2, 5) has an approximate value of one third, and pixel (3, 5) has an approximate value of one half. The remaining pixels have an alpha value of one. One mechanism to store the alpha values is as an ordered list, such as in an array, with values: ½, 1, 1, ˜⅓, 1, 1, 1, ˜½. Further, the ordered list may have a list offset for each row of pixels that denotes the starting value for the row in the ordered list. For example, the first row of pixels in the chunk has a list offset of zero because the first value in the list is for the first pixel of the first row of pixels. Similarly, the second row of pixels in the chunk has a list offset of four because the fifth value in the list is for the first pixel in the second row of pixels in the chunk. The list offset may also be maintained as an array.

Chunk 2 is also described similarly to chunk 1. As discussed above, chunk 2 is the pixel coverage data for the example shape (156) in pixel row 4 (162). Chunk 2 has a position (4, 2) because the chunk starts on pixel (4, 2). Further, chunk 2 has a height of one and width of four because the chunk covers one row of pixels and four columns of pixels. Within this chunk, the offset and length is zero and four, respectively, for the row of pixels. The alpha variables are described for each pixel in the chunk as follows: pixel (4, 2) and pixel (4, 4) have a value of one, pixel (4, 3) has a value of zero, and pixel (4, 5) has a value of one half. Thus, the alpha values are stored as an ordered list with values: 1, 0, 1, ½. The ordered list offset has a single value of zero because a single row is covered by the chunk and is affected by the ordered list.

Next, consider the scenario in which the example shape (156) is translated or moved after the pixel coverage data is stored in the graphics cache. FIG. 1D shows the example shape (156) in the image when the example shape (156) is moved down one row and to the left one column. If the alpha variables are stored so as to not be dependent on the position of the shape, such as using an ordered list, then the only variable in the pixel coverage data that is dependent on the position of the shape is the position variable. Thus, the pixel coverage data that is stored in the graphics cache may be used from the graphics cache. Specifically, by only updating the position variable for all chunks the pixel coverage data from the graphics cache may be used. In the example, the update to the position variable includes adding one to the value identifying the row and subtracting one from the value identifying the column. Thus, the position variable for the first chunk has a value of (2+1, 2−1) or (3, 1) because the new position for the first chunk is in the third row and first column. Similarly, the position variable for the second chunk has a value of (4+1, 2−1) or (5, 1) because the new position for the second chunk is in the fifth row and first column. As shown in the example, even when the shape is translated, the pixel coverage data may be used.

As discussed above, pixel coverage data may be stored for sub-pixels rather than for complete pixels. FIG. 1C shows an example image with sub-pixels. For the following example, consider when the example shape (156) is maintained in the graphics cache according to the sub-pixels shown in FIG. 1C. Further, consider the scenario in which the shape is divided into three chunks, chunk 1, chunk 2, and chunk 3. Chunk 1 includes the first two rows of pixels similar to the previous example. Chunk 2 includes the first part of the fourth row of pixels and chunk 3 includes the second part of the fourth row of pixels.

Chunk 1 has a position (3, 3) because the chunk starts on sub-pixel (3, 3). Alternatively, chunk 1 may be considered to have a position of (1, 1) on pixel (2, 2) because the chunk starts on row one, column one of pixel (2, 2). Further, chunk 1 has a height of four and width of seven because the chunk covers four rows of sub-pixels and seven columns of sub-pixels. Within this chunk, an offset and length pair is described for each row of pixels. The first row has an offset of one and a length of six because the first row starts on the second column of sub-pixels in the chunk and covers six sub-pixels. The offset and length for the remaining rows are zero and seven, respectively, because all sub-pixels in the each of the remaining rows are covered. The alpha variables are described for each sub-pixel in the chunk as an ordered list: ½, 1, 1, 1, 1, ˜⅓, ½, 1, 1, 1, 1, 1, ˜½, 1, 1, 1, 1, 1, 1, ˜⅞, 1, 1, 1, 1, 1, 1, 1. One skilled in the art will appreciate that the ordered list may be condensed. For example, a value may be listed once along with a number identifying the number of times the value occurs consecutively. Further, the ordered list has a list offset for each row of sub-pixels that denotes the starting value for the row of sub-pixels in the ordered list. Thus, the value of the list offsets for chunk 1 is zero for the first row, six for the second row, thirteen for the third row, and twenty for the fourth row.

Chunk 2 has a position of (7, 3), a width of two, and a height of two. The offset and width of each row of sub-pixels in chunk 2 is zero and two, respectively. The alpha variables have a value of one for each sub-pixel in the chunk. Finally, the list offset is zero for the first row of sub-pixels and two for the second row of sub-pixels.

Chunk 3 has a position of (7, 7), a width of three, and a height of two. The offset and width of each row of sub-pixels in the second chunk is zero and three, respectively. The alpha variables have a value of one for each sub-pixel in the chunk. Finally, the list offset is zero for the first row of sub-pixels and three for the second row of sub-pixels.

The description of the example shape (156) in FIGS. 1B-1D is intended solely for an example. The example shape (156) may be described using different variables. For example, rather than defining the example shape (156) as two chunks, the example shape may be described in a single chunk (156). Moreover, the values of the variables may change according to the numbering scheme used to specify pixels and sub-sampled pixels. For example, in some numbering schemes, the initial row of pixels or sub-sampled pixels may be designated as row one. In other numbering schemes, this initial row may be designated as row zero. Moreover, rather than using the above described variables to represent a chunk, other variables may be used for maintaining pixel coverage data. For example, each row of pixels may be defined by the position of the starting pixel and the ending pixel in the row. Further, the rows of sub-sampled pixels may be represented as starting sub-sampled pixel and ending sub-sampled pixel for the row of sub-sampled pixels.

Returning to the system of FIG. 1A, the system also includes a graphics application (104). A graphics application (104) includes functionality to create and update an image (100). Further, a graphics application (104) may be a user interface for another application. The graphics application (104) may define shapes using vector graphics.

In one or more embodiments of the invention, the graphics application (104) includes functionality to manipulate the graphics cache (102). Specifically, the graphics application (104) includes functionality to store and retrieve pixel coverage data for a shape (108) from the graphics cache (102). A graphics application (104) may further include functionality to create the graphics cache (102).

In one or more embodiments of the invention, the graphics cache and functionality provided by the graphics cache is defined in a rendering library (not shown). Specifically, the rendering library includes a class definition of a graphics cache. This class definition defines the methods that may be invoked by a graphics application to make use of a graphics cache. The rendering library may have methods for creating the graphics cache (102), adding pixel coverage data (108) for a shape (106) to the graphics cache (102), obtaining and modifying pixel coverage data (108) from the graphics cache (102), and invalidating the graphics cache (102) or a portion thereof. Thus, by instantiating an object of the graphics cache, the graphics application may use the graphics cache to render the image.

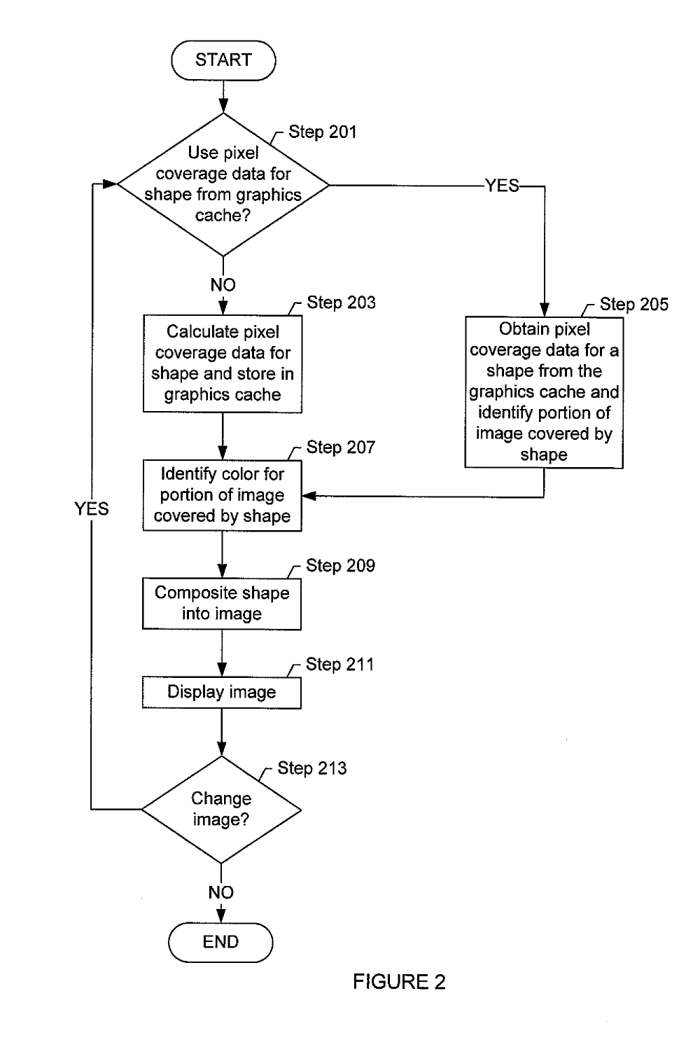

FIG. 2 shows a flowchart of a method in accordance with one or more embodiments of the invention. While the various steps in this flowchart are presented and described sequentially, one of ordinary skill will appreciate that some or all of the steps may be executed in different orders and some or all of the steps may be executed in parallel.

FIG. 2 shows a flowchart of a method for rendering a shape in an image using a graphics cache in accordance with one or more embodiments of the invention. Initially, individual shapes are identified. The individual shapes may be delineated separately in the graphics application. For example, the graphics application may define a shape as an object. The object may be a grouping of primitive objects representing other shapes. For example, consider the scenario in which a tree is to be rendered. The graphics application may have a tree object. The tree object may include multiple leaf objects for rendering each of the leaves, a tree trunk object, and multiple branch objects for each of the branches. The identified shape may be the complete tree (i.e., leaf objects, tree trunk object, and branch objects), the tree trunk and branch, or each component of the tree may be a separate shape.

Further, the identification of the shape may be specific to the graphics application. For example, if the graphics application specifies that the tree is in the background and does not change during several renderings of the image, then the entire tree may be the identified shape. Alternatively, if the graphics application has the leaves fall from the tree, then the tree trunk and branches may be one shape and each of the leaves may be separate shapes.

Once a shape is identified, a determination is made whether to use pixel coverage data for the shape that may be stored a graphics cache (Step 201). If pixel coverage data for the shape is stored in the graphic cache, that pixel coverage data may be used if the pixel coverage data has not been marked as obsolete due to some change in the shape. In one or more embodiments of the invention, the pixel coverage data may be considered obsolete and marked as such when the shape is rotated, flipped, or resized.

If pixel coverage data for the shape is not in the graphics cache or a determination is made not to use the pixel coverage data for the shape in the graphics cache, then the pixel coverage data for the shape is calculated and stored in the graphics cache (Step 203). Calculating the pixel coverage data may be performed using any of a variety of techniques known in the art. For example, a rasterization process, such as scan conversion, may be used to calculate the pixel coverage data.

Continuing with FIG. 2, while calculating the pixel coverage data, variables for storing the pixel coverage data may be determined from the calculations. In order to partition the shape into chunks, the graphics application may have a technique that is shape dependent for identifying each chunk. In one technique, the chunks may be greedily defined by identifying the largest convex portions of the shape. Another method may involve arbitrarily specifying a number of rows or columns for each chunk. The manner in which chunks are defined may be affected by the capabilities of the computer system. For example, a determination may be made between optimizing memory usage or processing time to generate the image when defining a chunk.

Regardless of how a chunk is defined, once a chunk is defined, the pixel coverage data for the chunk may be identified from the chunk. For example, the uppermost left pixel of the chunk may be specified as the value for the position variable. Similarly, the height variable may be defined. Further, the offset and length pair may be identified from the chunk. Once variables, such as the height, width, the offsets, and lengths, are calculated for a chunk, then the pixel coverage data for the chunk may be stored in the graphics cache. Specifically, the chunk is stored in the shape cache for the shape in the graphics cache. This process is repeated for each chunk in the shape so that the shape cache includes all chunks of the shape.

Alternatively, if a determination is made to use the pixel coverage data from the graphics cache, then the pixel coverage data for the shape is obtained from the graphics cache and the portion of the image that is covered by the shape is identified. The pixel coverage data for the shape may be obtained from the graphics cache by identifying each chunk that belongs to the shape. In some embodiments of the invention, the graphics application maintains a data structure that correlates chunks to shapes. This data structure may be in the graphics cache or may be stored in other memory. The graphic application may use this data structure to identify each chunk belonging to a shape.

Once the chunks are identified, the pixels in the portion of the image covered by the shape may be determined from the pixel coverage data of the chunks. Further, the pixel coverage data may be reused when any translations (i.e., a change in position of the shape) occur. Calculating the translation of the pixel coverage data may be performed by determining the change in the vertical and horizontal direction from the current position to the position stored in the graphics cache. Based on the change in the horizontal and vertical direction, the position variable may be updated. For example, if the shape moves by five pixels in the horizontal direction and three pixels in the vertical direction, then the new position may be calculated by adding five to the column value of the position variable stored in the graphics cache and three to the row value of the position variable stored in the graphics cache.

Once the updated value for the position variable is calculated, the portion of the image covered by the shape may be calculated from the updated position variable and the pixel coverage data in the graphics cache. Specifically, since, in one or more embodiments of the invention, the variables defining the chunk are defined relative to the position variable, when the value of the position variable is determined, the remaining pixels of the chunk may be determined. For example, a chunk with a position variable specifying pixel (3, 4) and having a height of two and a width of three includes pixel (3, 4), pixel (3, 5), pixel (3, 6), pixel (4, 4), pixel (4, 5), and pixel (4, 6). Similarly, the offset and lengths for rows of sub-sampled pixels in each row of pixels may be identified.

After identifying the portion of the image covered by the shape, the color for the portion of the image covered by the shape is determined (Step 207). Specifically, a color is associated with each pixel covered by the shape. Various techniques known in the art may be performed to identify the color for each pixel. For example, the graphics application may specify that the shape specify the color as an ordered triple of variables representing values for an amount of red, green, and blue in each pixel in the shape. In the example, the graphics application may specify that a shape is a red ball. Alternatively, the color may be generated from a function. The function may be defined according to a position and/or intensity of a virtual light source defined in the image or using other such techniques.

Further, all shapes in the image are composited into the target image using the coverage and color information of the shapes (Step 209). Compositing a shape into the image may be performed using the painter's algorithm. In the painter's algorithm, each shape is painted on top of the previously painted ones. Initially, the background of the image is empty. Shapes may be composited with the background, for example, by using the Porter Duff Compositing rules. When a shape is composited with the background, the shape becomes a part of the background and in some scenarios is not distinguishable from the background. Thus, when subsequent shapes are processed, the subsequent shapes are composited with the background which includes the previously added shape(s).

Further, the image is displayed (Step 211). Displaying the image involves changing the colors of the pixels on a screen in a manner such that the image is visible to the user. Alternatively, if a physical copy of the image is to be generated, then displaying the image may involve printing the image in a physical medium.

Once the image is displayed, a determination is made whether the image is changed (Step 213). The displayed image may change over time as specified by the graphics application. For example, if the image is a part of a collection of images showing a computer-generated circle moving across a screen, then the image changes when the graphics application causes the circle to move. The image may also change in the example, when the color of the circle changes. If the image is changed by the graphics application, the changes need to be reflected in the displayed image (i.e., a new image needs to be rendered). The graphics cache may be used as described above to render the shapes and create the changed image. Even when the change does affects the color of the shape, the pixel coverage data for the shape in the graphics cache may be used in the rendering process rather than recalculating the pixel coverage. Specifically, because color is not stored with the pixel coverage data in the graphics cache, recalculating the pixel coverage data is unnecessary when the shape changes color. Further, when a translation of the shape occurs, and the shape appears to move, the pixel coverage data in the graphics cache may be used by simply updating the position variable as discussed above.

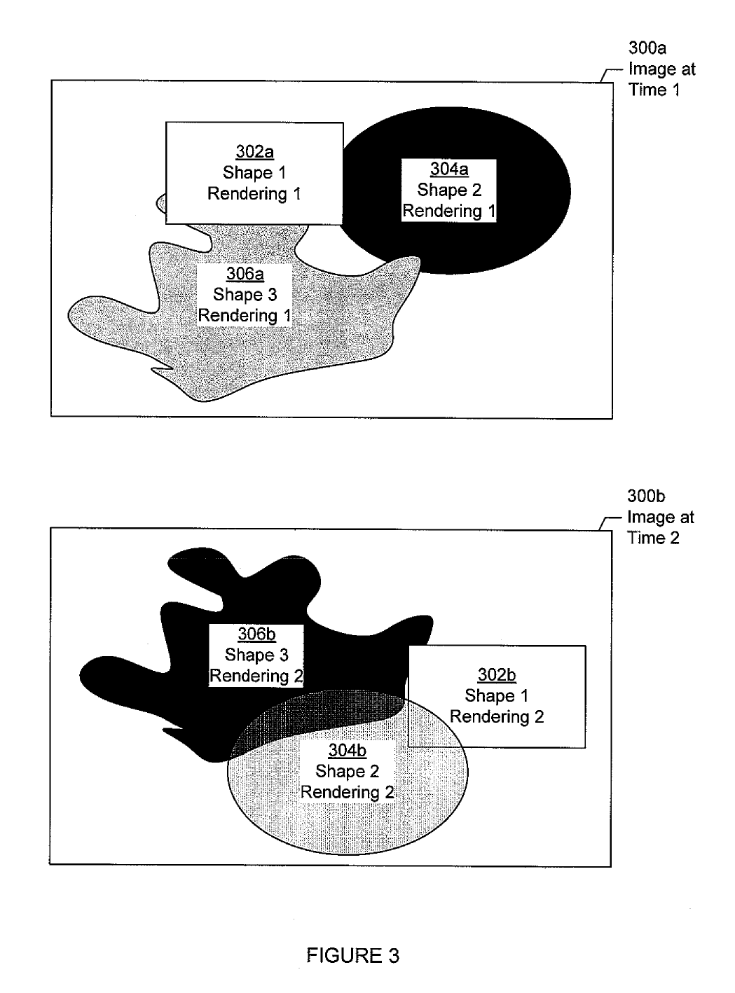

FIG. 3 shows an example in accordance with one or more embodiments of the invention. In particular, FIG. 3 shows an image at time 1 (300a) and an image at time 2 (300b), Each shape in the image at time 2 (300b) is rendered using the pixel coverage information generated and stored in a graphics cache when the image at time 1 (300a) was rendered.

As shown in FIG. 3, the image at time 1 (300a) has a solid white rectangle (i.e., Shape 1 Rendering 1 (302a)) in the foreground, a black oval (i.e., Shape 2 Rendering 1 (304a)) in the background, and a grey blob (i.e., Shape 3 Rendering 1 (306a)) in the middle ground. Each shape (i.e., Shape 1 Rendering 1 (302a), Shape 2 Rendering 1 (304a), Shape 3 Rendering 1 (306b)) in the image at time 1 (300a) may be rendered individually. When the rectangle (i.e., Shape 1 Rendering 1 (302a)) is rendered, the pixel coverage data for the rectangle is added to the graphics cache. However, the color, i.e., white, of the individual pixels in the rectangle the color white is not stored in the graphics cache. Similarly, when the oval (i.e., Shape 2 Rendering 1 (304a)) and the blob (i.e. Shape 3 Rendering 1 (306a)) are rendered, the pixel coverage data for the oval and the blob may be added individually to the graphics cache. After determining the pixel coverage data, the color value for each pixel is identified based on the shape and the target image's background. Thus, the image at time 1 (300a) is generated.

Next, consider the scenario in which at some later time the image changes. Image at time 2 (300b) shows a change in the image in which pixel coverage data in the graphics cache may be used. As shown in FIG. 3, in contrast to the image at time 1 (300a), the blob (i.e., Shape 3 Rendering 2 (306b)) in image at time 2 (300b) is a different color, is in the background and has moved. Further, the oval (i.e., Shape 2 Rendering 2 (304b)) in image at time 2 (300b) is a different color, is translucent, moved, and is in the foreground. Finally, the rectangle (i.e., Shape 1 Rendering 2 (302b)) in image at time 2 (300b) has moved and is positioned to appear between the blob (i.e., Shape 3 Rendering 2 (306b)) and the oval (i.e., Shape 2 Rendering 2 (304b)).

The pixel coverage data for each shape in the image that was generated for the image at time 1 (300a) is used to render the image at time 2 (300b). Specifically, when rendering the rectangle (i.e., Shape 1 Rendering 2 (302b)) in image at time 2 (300b), the pixel coverage data for the rectangle (i.e., Shape 1 Rendering 1 (302b)) may be obtained from the graphics cache. While or after obtaining the pixel coverage data, the portion of the image covered by the rectangle (i.e., Shape 1 Rendering 2 (302b)) is identified by determining the difference between the rectangle (i.e., Shape 1 Rendering 1 (302a)) in the image at time 1 (300a), and the rectangle (i.e., Shape 1 Rendering 2 (302b)) in the image at time 2 (300b). The position variable stored in the graphics cache may be updated to reflect the difference in location. Once the image coverage data for the rectangle is obtained and the portion of the image covered by the rectangle is identified, then the color value of white is composited with the background of the target image for each pixel in the shape to identify the color value of each pixel in the rectangle.

Similarly, when rendering the oval (i.e., Shape 2 Rendering 2 (304b)), the pixel coverage data for the oval (i.e., Shape 2 Rendering 1 (304a)) for image at time 1 (300a) is used from the graphics cache. The position variable is updated to reflect the change in position of the oval. Once the pixel coverage data is obtained and the portion of the image covered by the oval is identified, the color value of grey is composited with the background of the target image for each pixel in the oval to identify the color value of each pixel in the oval.

Additionally, when rendering the blob (i.e., Shape 3 Rendering 2 (306b)), the pixel coverage data for the blob (i.e., Shape 3 Rendering 1 (306a)) for image at time 1 (300a) is used from the graphics cache. The position variable is updated to reflect the change in position of the blob. Once the pixel coverage data is obtained for the blob and the portion of the image covered by the blob is identified, the color value of black is composited with the background of the target image for each pixel in the blob to identify the color value of each pixel in the blob.

When the color has been identified for the shapes, the shapes are composited. Specifically, the blob (i.e., Shape 3 Rendering 2 (306b)) is composited with a white background as an opaque shape. The square (i.e., Shape 1 Rendering 2 (302b)) is composited with the background which now includes the blob (i.e., Shape 3 Rendering 2 (306b)). Finally, the oval (i.e., Shape 2 Rendering 2 (304b)) is composited with the background which now includes the blob (i.e., Shape 3 Rendering 2 (306b)) and the square (i.e., Shape 1 Rendering 2 (302b)). Because the shapes are stored in the graphics cache, calculations are not required to obtain pixel coverage data.

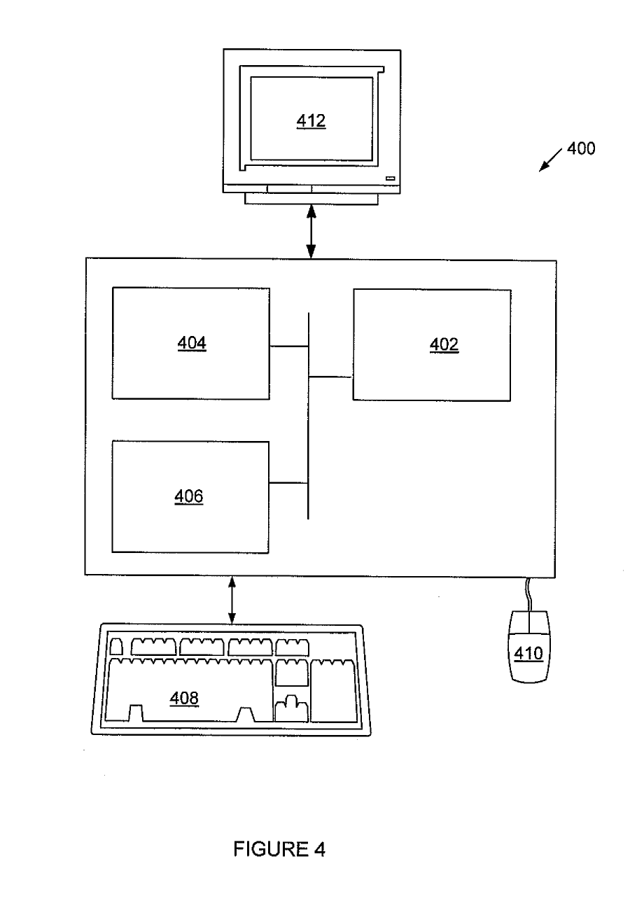

Embodiments of the invention may be implemented on virtually any type of computer regardless of the platform being used. For example, as shown in FIG. 4, a computer system (400) includes a processor (402), associated memory (404), a storage device (406), and numerous other elements and functionalities typical of today's computers (not shown). The computer (400) may also include input means, such as a keyboard (408) and a mouse (410), and output means, such as a monitor (412). Those skilled in the art will appreciate that these input and output means may take other forms. The computer system (400) is connected to a local area network (LAN) or a wide area network (e.g., the Internet) (not shown) via a network interface connection (not shown).

In one or more embodiments of the invention, the computer system (400) is a mobile device. For example, the computer system may be a cellular telephone, a personal digital assistant, a geographical positioning system, a music player, or any other type of mobile device. Alternatively, the computer system (400) may correspond to a desktop computer, laptop computer, or any other non-mobile computing device.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention (e.g., graphics cache, display, graphics application, processor, etc.) may be located on a different node within the distributed system. In one embodiment of the invention, the node is a computer system. Alternatively, the node may be a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

In one or more embodiments of the invention, the performance of graphics application when rendering a changed image may be be improved. Specifically, pixel coverage data for shapes in the image may be stored in a graphics cache when the image is initially rendered and may be used in subsequent renderings of the image rather than recalculating the pixel coverage data. Specifically, by storing the pixel coverage data, recalculation of the pixel coverage data is not necessary when the color or the position of the shape changes. Further, memory efficiency may also be improved by storing the pixel coverage data rather than the completely rendered shape.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for rendering an image comprising:
obtaining pixel coverage data for a first shape from a graphics cache;
determining a first portion of the image covered by the first shape using the pixel coverage data for the first shape; and
displaying the image with the first portion of the image covered by the first shape.

2. The method of claim 1, wherein the pixel coverage data for the first shape is stored in the graphics cache as a plurality of chunks.

3. The method of claim 2, wherein each of the plurality of chunks comprises a height, a width, and a position of the chunk.

4. The method of claim 3, wherein the position is with respect to the image.

5. The method of claim 3, wherein the height identifies a number of sub-sampled pixels.

6. The method of claim 1, wherein determining a first portion of the image further comprises:
performing a translation on the pixel coverage data for the first shape.

7. The method of claim 1, further comprising:
calculating the pixel coverage data for the first shape; and
storing the pixel coverage data in the graphics cache.

8. The method of claim 1, further comprising:
identifying color values for a plurality of pixels in the first portion of the image after obtaining the pixel coverage data for the first shape.

9. The method of claim 8, further comprising:
determining a second portion of the image covered by the first shape using the pixel coverage data for the first shape; and
identifying color values for a plurality of pixels in the second portion of the image,
wherein the image is displayed with the first portion of the image and the second portion of the image covered by the first shape.

10. The method of claim 1, further comprising:
obtaining pixel coverage data for a second shape from the graphics cache;
identifying a second portion of the image covered by the second shape using to the pixel coverage data for the second shape; and
compositing the first shape and the second shape using the painter's algorithm to create a composition,
wherein displaying the image comprises displaying the composition.

11. A system for rendering an image comprising:
a graphics cache configured to store pixel coverage data for a plurality of shapes; and
a graphics application configured to:
obtain pixel coverage data for a first shape of the plurality of shapes from the graphics cache;
determine a first portion of the image covered by the first shape using the pixel coverage data for the first shape; and
display the image with the first portion of the image covered by the first shape.

12. The system of claim 11, wherein the pixel coverage data for the first shape is stored in the graphics cache as a plurality of chunks.

13. The system of claim 12, wherein each of the plurality of chunks comprises a height, a width, and a position of the chunk.

14. The system of claim 13, wherein the height identifies a number of sub-sampled pixels.

15. The system of claim 11, wherein the graphics application is further configured to determine a first portion of the image covered by the first shape by performing a translation on the pixel coverage data for the first shape.

16. The system of claim 11, wherein the graphics application is further configured to:
calculate pixel coverage data for the first shape; and
store the pixel coverage data for the first shape in the graphics cache.

17. The system of claim 11, wherein the graphics application is further configured to:
obtain pixel coverage data for a second shape from the graphics cache;
identify a second portion of an image covered by the second shape using the pixel coverage data for the second shape;
composite the first shape and the second shape to create a composition; and
display the image by displaying the composition.

18. The system of claim 11, wherein the image is displayed on a mobile device.

19. A computer readable medium comprising computer readable program code embodied therein for causing a computer system to:
obtain pixel coverage data for a first shape from a graphics cache;
determine a first portion of the image covered by the first shape using the pixel coverage data for the first shape; and
display the image with the first portion of the image covered by the first shape.

20. The computer readable medium of claim 19, wherein the computer readable program code for causing a computer system to obtain pixel coverage data is comprised in a rendering library.
